(19) United States
(12) Patent Application Publication
(10) Pub. No.: US 2015/0312667 A1
(43) Pub. Date: Oct. 29, 2015

(54) EARPHONE RECEIVING CASE

(71) Applicants: Fu Tai Hua Industry (Shenzhen) Co., Ltd., Shenzhen (CN); HON HAI PRECISION INDUSTRY CO., LTD., New Taipei (TW)

(72) Inventor: QIAN LEI, Shenzhen (CN)

(21) Appl. No.: 14/527,065

(22) Filed: Oct. 29, 2014

(30) Foreign Application Priority Data
Apr. 29, 2014 (CN) 201410176489.8

(51) Int. Cl. H04R 1/10; B65H 75/40; B65H 75/44; H02G 11/02

(52) U.S. Cl. CPC H04R 1/1033; H02G 11/02; B65H 75/40; B65H 75/4471; H04R 2499/11; B65H 2701/34

(57) ABSTRACT

An earphone receiving case includes a housing, a cover attached to the housing, a handle, a rotation apparatus, a rotation tray, a clasping member and an elastic member. A part of the handle is exposed out of the housing. The rotation apparatus is rotationally attached to the housing and attached to the handle. The rotation tray is rotationally attached to the cover and defines a plurality of clasping slots. One end of the clasping member is rotationally attached to the rotation apparatus. The other end of the first clasping member abuts against one clasping slot. The elastic member is attached to the first clasping member. When the handle is pushed, the clasping member can break away from the one clasping slot. The elastic member responds to push the clasping member to be received in another one clasping slot when the clasping member breaks away from the one clasping slot.

### CROSS-REFERENCE TO RELATED APPLICATIONS

This application claims priority to Chinese Patent Application No. 201410176489.8 filed on Apr. 29, 2014, in the China Intellectual Property Office, the contents of which are incorporated by reference herein.

### FIELD

The present disclosure relates to cases for protecting electronic devices.

### BACKGROUND

Earphones can be inserted into portable electronic devices, such as mobile phones and music playing devices, for listening to music. A headphone cable for the earphone can be long or short.

### BRIEF DESCRIPTION OF THE DRAWING

Implementations of the present technology will now be described, by way of example only, with reference to the attached figures.

FIG. 1 is an isometric view of an embodiment of an earphone receiving case.

FIG. 2 is an exploded, isometric view of the earphone receiving case in FIG. 1.

FIG. 3 is similar to FIG. 1, but viewed from another angle.

FIG. 4 is a schematic view of the earphone receiving case in FIG. 2 with a headphone cable received in a housing.

FIG. 5 is similar to FIG. 1, but viewed from another angle with a housing and a cover omitted.

FIG. 6 is an enlarged view of a housing of the earphone receiving case in FIG. 2.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising” means “including, but not necessarily limited to”; it specifically indicates open-ended inclusion or membership in a so-described combination, group, series and the like.

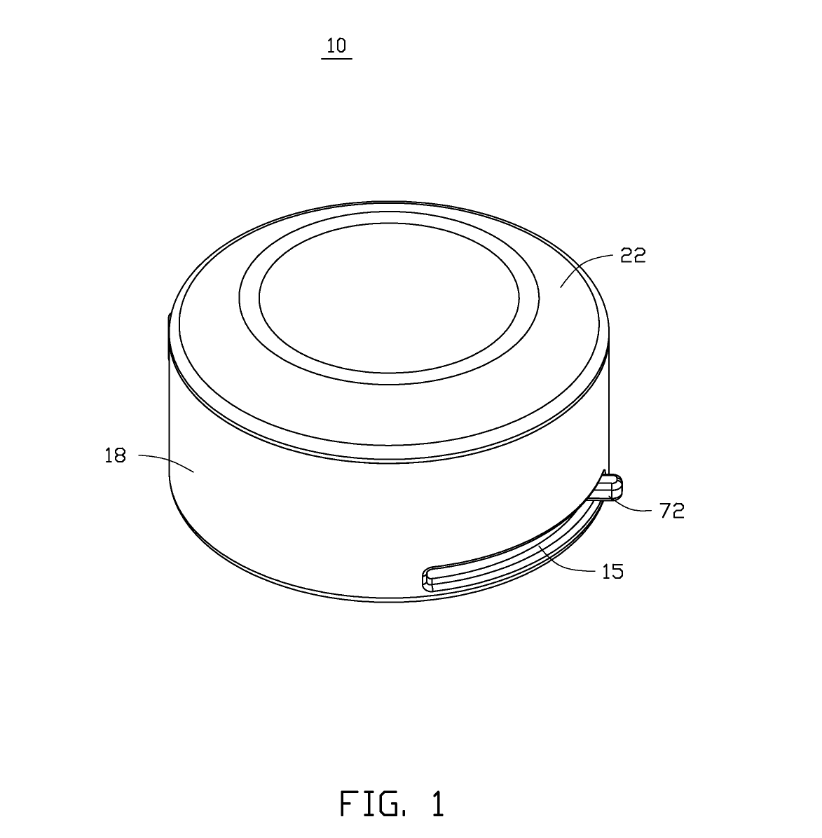

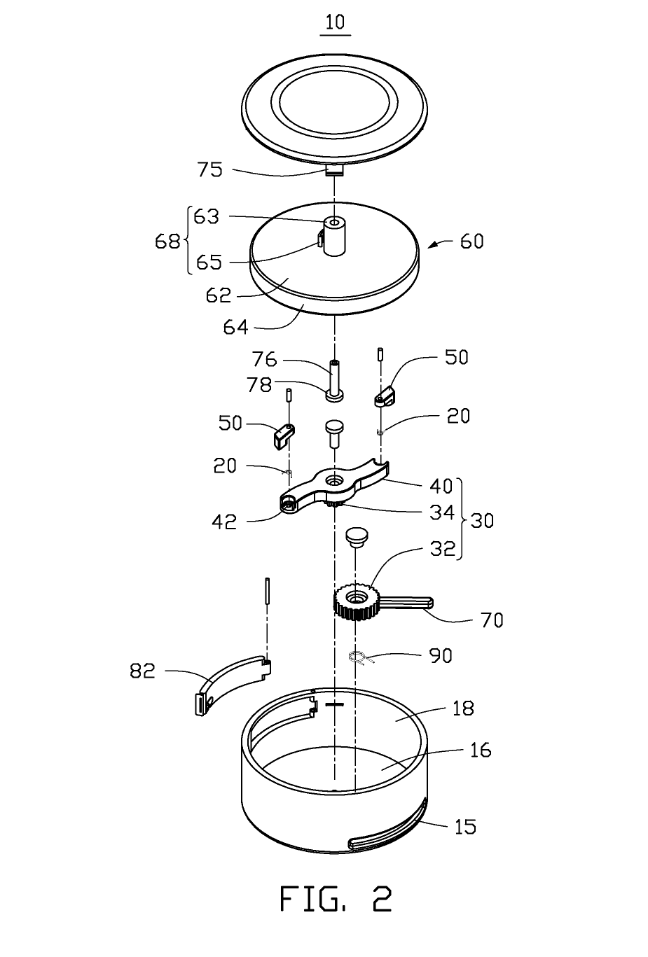

FIGS. 1-2 illustrate an earphone receiving case 10. The earphone receiving case 10 includes a housing 12, two first elastic members 20, a rotation apparatus 30, two clasping members 50, a rotation tray 60, a handle 70 and a cover 72. The housing 12 and the cover 14 cooperatively define a receiving space (not labeled). The housing 12 includes a bottom shell 16 and a periphery sidewall 18 protruding around an edge of the bottom shell 16. The rotation tray 60 and the rotation apparatus 30 are both received in the receiving space. The periphery sidewall 18 defines a through hole 15. A first end of the handle 70 is attached to the rotation apparatus 30. A second end of the handle 70 passes through the through hole 15 to be exposed from the housing 12.

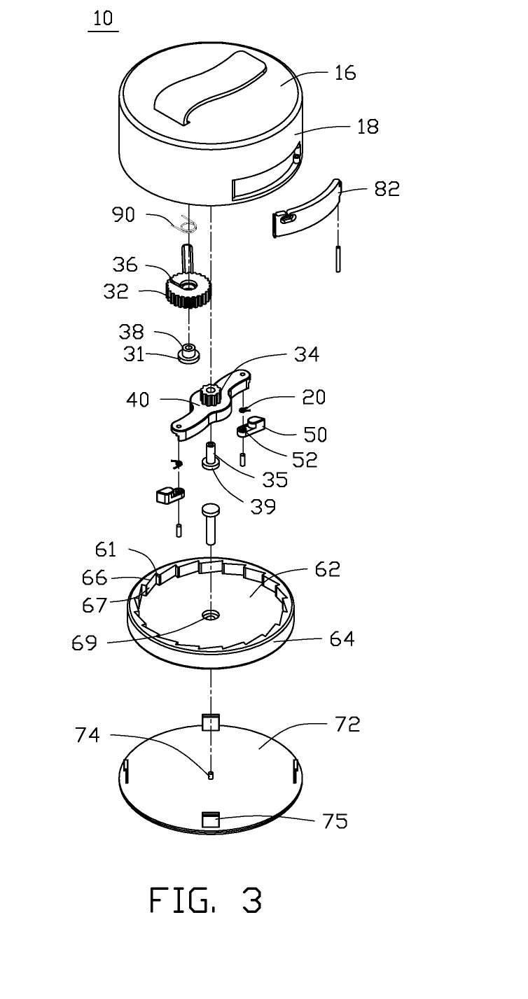

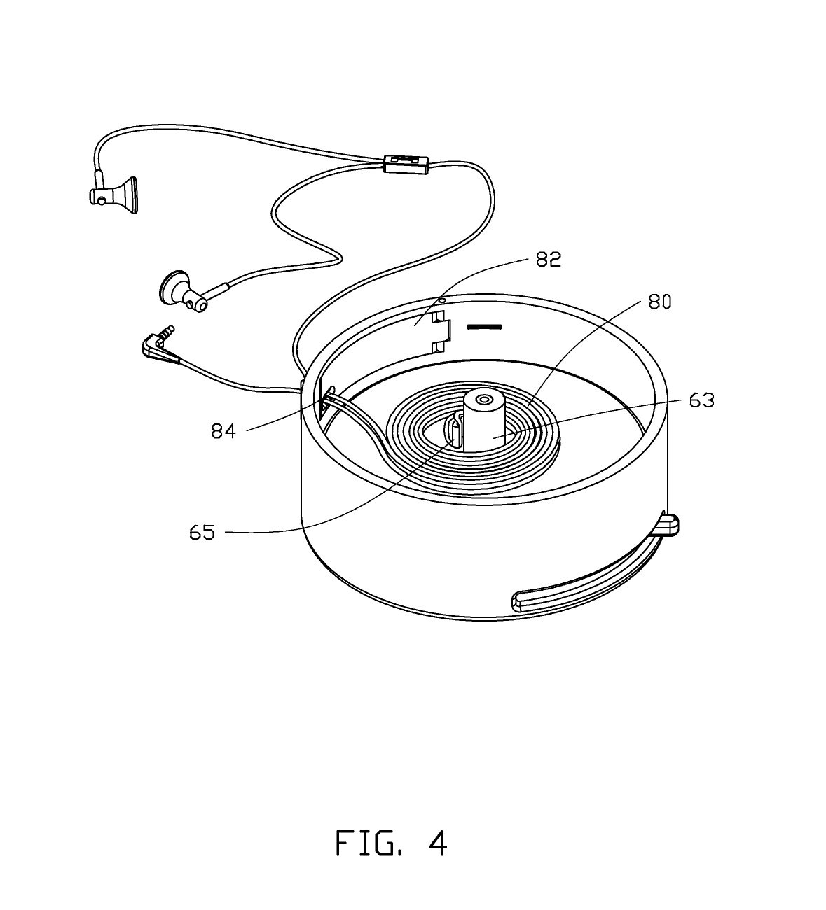

FIGS. 3 and 4 illustrate that the rotation tray 60 includes a disk 62 and a protrusion 64 protruding around an edge of the disk 62 toward the bottom shell 16. A number of clasping slots 66 are defined on an inner surface of the protrusion 64. The rotation tray 60 further includes a rotation member 68 protruding from a side of the disk 62 adjacent to the cover 72. The rotation member 68 includes a rotation portion 63 rotationally attached to the cover 72 and an arm portion 65 attached to the rotation portion 63. A part of a headphone cable 80 is sleeved on the arm portion 65.

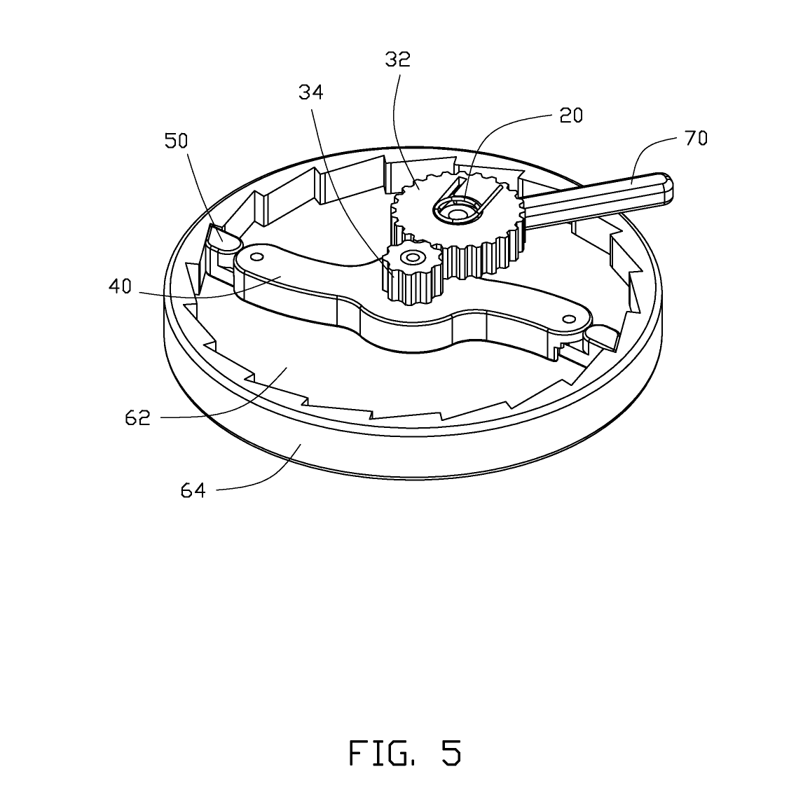

FIG. 5 illustrates that the rotation apparatus 30 includes a first gear 32, a second gear 34 and a rotation piece 40. The first gear 32 is arranged between the disk 62 and the bottom shell 16. The first gear 32 is rotationally attached to the bottom shell 16. The second gear 34 is rotationally attached to the bottom shell 16 and engages with the first gear 32. The rotation piece 40 is attached to a first end of the second gear 34. Thus, the rotation piece 40 can rotate when the second gear 34 rotates. A first end of the two clasping members 50 are rotationally attached to two ends of the rotation piece 40 by two rotation shafts (not labeled). A second end of the two clasping members 50 abut against two clasping slots 66. The first end of the handle 70 is attached to the first gear 32. When the second end of the handle 70 is pushed to rotate the first gear 32, the second gear 34 rotates and the rotation piece 34 rotates following the rotation of the second gear 34. When the rotation piece 34 rotates, the second end of the two clasping members 50 can push the rotation tray 60 to rotate around the rotation member 68. The headphone cable 80 can wrap the rotation member 68 following the rotation of the rotation tray 60.

The clasping slot 66 is defined by an abutting surface 61 and a supporting surface 67 jointing with the abutting surface 61. The abutting surface 61 extends from a fringe of the supporting surface 67 toward an end of the rotation piece 40 adjacent to the abutting surface 61. Thus, when the rotation tray 60 rotates, the second end of the two clasping members 50 rotates around the two ends of the rotation member 40, the second end of the two clasping members 50 can still abut against the abutting surface 61 and move away from the supporting surface 67. When the clasping member 50 pushes the abutting surface 61, the rotation tray 60 can keep rotating. The two clasping members 50 break away from the abutting surface 61 when moved, the rotation tray 60 stops rotating. The headphone cable 80 also stops wrapping around the rotation member 68.

The two first elastic members 20 are deformed when the second end of the two clasping members 50 move away from the supporting surface 67. When the two clasping members 50 break away from the abutting surface 61, the two first elastic members 20 rebound, pushing the two ends of the rotation piece 40 to rotate the two clasping members 50 in a reverse direction to be received in another of the two clasping slots 66. The two clasping members 50 complete a cycle of movement. The handle 70 is pushed a number of times, breaking the two clasping members 50 away from two clasping slots 66, to be received in another two clasping slots 66. Thus, the headphone cable 80 can surround the arm portion 65 bit by bit. The headphone cable 80 can be received in the earphone receiving case 10.

At least one embodiment, the first elastic member 20 is a torsion spring. The torsion spring includes a main body and two ends extending from the main body. One end of the clasping member 50 defines a “6” shaped groove 52. One end of the rotation piece 40 defines a “6” shaped groove 42. A part of main body and one end of the torsion is received in the groove 52. Another part of the main body and another end of the torsion is received in the groove 42.

In one embodiment, when the handle 70 is pushed to move from one end of the through hole 15 to another end of the through hole 70, the two clasping members 50 break away two clasping slots 66.

The earphone receiving case 10 further includes a second elastic member 90. When the handle 70 is pushed, the second elastic member 90 is deformed. When the handle 70 is released, the second elastic member 90 rebounds to push the handle 70 to reset. During the resetting of the handle 70, the first gear 32, the second gear 34 and the rotation piece 40 all rotate in a reverse direction. Thus, the rotation piece 40 can push the two clasping members 50 in a reverse direction to be received in another two clasping slots 66.

In one embodiment, the second elastic member 90 is a torsion spring. The torsion spring includes a main body and two ends extending from the main body. One end of the first gear 32 defines a “6” shaped groove 36. The bottom shell 16 defines a “6” shaped groove 19. A part of main body and one end of the torsion is received in the groove 36. Another part of the main body and another end of the torsion is received in the groove 19.

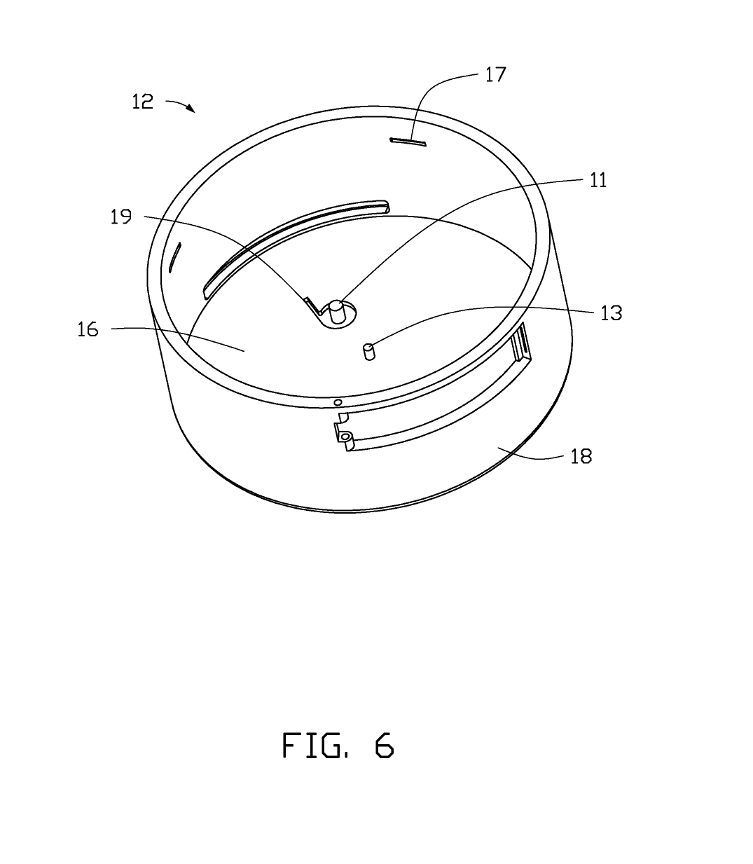

FIG. 6 illustrates that two fixing shafts 11, 13 protrude from the bottom shell 16. The two fixing shafts 11, 13 define threads. Two rotation shafts 38, 35 define two threaded holes (not labeled). The two rotation shafts 38, 35 are received in two axle holes (not labeled) of the first gear 32 and second gear 34. The two fixing shafts 11, 13 are screwed in the threaded holes of the two rotation shafts 38, 35. Two restriction portions 31, 39 protrude from the radial of one end of the two rotation shafts 38, 35. The first gear 32 defines a fixing hole (not labeled) communicating with the axle hole. The second gear defines a fixing hole (not labeled) communicating with the axis hole. The two restriction portion 31, 39 are received in the two fixing holes to rotationally attached the first gear 32 and the second gear 34 to the bottom shell 16.

A fixing shaft 74 is protruding from the cover 72. The fixing shaft 74 defines threads. The disk 62 defines a through hole 69. The through hole 69 includes a small hole (not labeled) adjacent to the cover 72 and a big hole (not labeled) communicating with the small hole. A rotation shaft 76 defining a threaded hole is received in the small hole. The fixing shaft 74 is screwed in the threaded hole of the rotation shaft 76. A restriction portion 78 protrudes from one end of the rotation shaft 76. The restriction portion 78 is received in the big hole rotationally attaching the rotation tray 60 to the cover 72.

The periphery sidewall 18 defines a number of clasping holes 17. The cover 72 includes a number of clasping pieces 75. The clasping pieces 75 are clasped in the clasping holes 17 attaching the cover 72 to the housing 12.

FIG. 4 illustrates that the periphery sidewall 18 defines a receiving hole (not labeled). An arc door 82 is rotationally received in the receiving hole. The arc door 82 defines a through hole 84. One end of the headphone cable 80 passes through the through hole 84 to be exposed out of the earphone receiving case 10.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An earphone receiving case comprising:
a housing;
a cover attached to the housing;
a handle, a first end of the handle exposed from the housing;
a rotation apparatus rotationally attached to the housing and attached to a second end of the handle;
a rotation tray rotationally attached to the cover and defining a plurality of clasping slots, the rotation tray configured to be attached to a headphone cable;
a first clasping member, a first end of the first clasping member rotationally attached to the rotation apparatus, a second end of the first clasping member abutting against a clasping slot from the plurality of clasping slots; and
a first elastic member attached to the first clasping member;
wherein when the handle is pushed, the rotation apparatus rotates, the second end of the first clasping member pushes the rotation tray to rotate and rotates around the rotation apparatus to break away from the one clasping slot, and the first elastic member is configured to provide elastic force to push the second end of the first clasping member to be received in another clasping slot from the plurality of clasping slots when the second end of the first clasping member breaks away form the one clasping slot.

2. The earphone receiving case as claimed in claim 1, wherein the rotation apparatus comprises a rotation piece, the first clasping member is rotationally attached to one end of the rotation piece, the clasping slot is defined by an abutting surface and a supporting surface jointing with the abutting surface, the abutting surface extends from a fringe of the supporting surface toward the one end of the rotation piece adjacent to the abutting surface.

3. The earphone receiving case as claimed in claim 2, wherein the rotation apparatus further comprises a first gear and a second gear rotationally attached to the housing and engaged with the first gear, the rotation piece is attached to one end of the second gear, the second end of the handle is attached to the first gear.

4. The earphone receiving case as claimed in claim 1, wherein the clasping member and the rotation apparatus respectively define a groove, two ends of the first elastic member abut against in the two grooves.

5. The earphone receiving case as claimed in claim 4, wherein the first elastic member comprise a main body between the two ends of the first elastic member, the two grooves are “6” shaped, a part of the main body is received in one groove, and another part of the main body is received in another groove.

6. The earphone receiving case as claimed in claim 5, wherein the first elastic member is a torsion spring.

7. The earphone receiving case as claimed in claim 1, further comprising a second elastic member attached to the rotation apparatus, the second elastic member is configured to provide elastic force to push the rotation apparatus to reset when the second end of the first clasping member breaks away form the one clasping slot.

8. The earphone receiving case as claimed in claim 7, wherein the rotation apparatus and the housing respectively define a groove, two ends of the second elastic member abut against in the two grooves.

9. The earphone receiving case as claimed in claim 1, further comprising a second clasping member, a first end of the second clasping member is rotationally attached to the rotation apparatus, a second end of the first clasping member abuts against another one of the plurality of clasping slots.

10. The earphone receiving case as claimed in claim 1, wherein the rotation tray comprise a disk and a protrusion protruding around an edge of the disk, the plurality of clasping slots are defined on the protrusion.

11. An earphone receiving case comprising:
a housing;
a cover attached to the housing;
a handle, a part of the handle exposed out of the housing;
a rotation apparatus rotationally attached to the housing and attached to the handle;
a rotation tray rotationally attached to the cover and defining a plurality of clasping slots, the rotation tray configured to be attached a headphone cable;
a first clasping member, a first end of the first clasping member rotationally attached to the rotation apparatus, a second end of the first clasping member abutting against one clasping slot; and
a first elastic member attached to the first clasping member;
wherein the handle is pushed to drive the rotation apparatus rotates, the second end of the first clasping member pushes the rotation tray to rotate when the rotation apparatus rotates, and the first clasping member can break away from the one clasping slot when the rotation tray rotates and can be received in another one clasping slot under an elastic force provided by the first elastic member.

12. The earphone receiving case as claimed in claim 11, wherein the rotation apparatus comprises a rotation piece, the first clasping member is rotationally attached to one end of the rotation piece, the clasping slot is defined by an abutting surface and a supporting surface jointing with the abutting surface, the abutting surface extends from a fringe of the supporting surface toward the one end of the rotation piece adjacent to the abutting surface.

13. The earphone receiving case as claimed in claim 12, wherein the rotation apparatus further comprises a first gear and a second gear rotationally attached to the housing and engaged with the first gear, the rotation piece is attached to one end of the second gear, the second end of the handle is attached to the first gear.

14. The earphone receiving case as claimed in claim 11, wherein the clasping member and the rotation apparatus respectively define a groove, two ends of the first elastic member abut against in the two grooves.

15. The earphone receiving case as claimed in claim 14, wherein the first elastic member comprise a main body between the two ends of the first elastic member, the two grooves are “6” shaped, a part of the main body is received in one groove, and another part of the main body is received in another groove.

16. The earphone receiving case as claimed in claim 15, wherein the first elastic member is a torsion spring.

17. The earphone receiving case as claimed in claim 11, further comprising a second elastic member attached to the rotation apparatus, the second elastic member is configured to provide elastic force to push the rotation apparatus to reset when the second end of the first clasping member breaks away form the one clasping slot.

18. The earphone receiving case as claimed in claim 17, wherein the rotation apparatus and the housing respectively define a groove, two ends of the second elastic member abut against in the two grooves.

19. The earphone receiving case as claimed in claim 11, further comprising a second clasping member, a first end of the second clasping member is rotationally attached to the rotation apparatus, a second end of the first clasping member abuts against another one of the plurality of clasping slots.

20. The earphone receiving case as claimed in claim 11, wherein the rotation tray comprise a disk and a protrusion protruding around an edge of the disk, the plurality of clasping slots are defined on the protrusion.
